(19) United States
(12) Patent Application Publication
(10) Pub. No.: US 2022/0363052 A1
(43) Pub. Date: Nov. 17, 2022

(54) PRINTING DEVICE, TERMINAL DEVICE, PRINTING SYSTEM, PRINTING METHOD, AND STORAGE MEDIUM

(71) Applicant: CASIO COMPUTER CO., LTD., Tokyo (JP)

(72) Inventor: Shuichi YAMASAKI, Fussa-shi, Tokyo (JP)

(21) Appl. No.: 17/761,397

(22) PCT Filed: Jul. 13, 2020
(86) PCT No.: PCT/JP2020/027219

§ 371 Date: Mar. 17, 2022

(30) Foreign Application Priority Data
Sep. 20, 2019 (JP) 2019-172235

(51) Int. Cl. B41J 2/045

(52) U.S. Cl. CPC B41J 2/04505; B41J 2/04586

(57) ABSTRACT

A printing device including: an ejector that ejects a first droplet to a print medium partially having a curved surface while moving in a first direction, and ejects a second droplet corresponding to the first droplet to the print medium while moving in a second direction opposite to the first direction; and a processor that obtains correction level information based on a distance between the print medium and the ejector and reference data that associates a correction level with each area obtained by dividing the print medium into multiple areas in a width direction and that performs ejection control of at least one of ejection of the first droplet and ejection of the second droplet based on the obtained correction level information so that a landing position on the print medium of the first droplet and a landing position of the second droplet substantially match each other.

### TECHNICAL FIELD

The present invention relates to a printing device, a terminal device, a printing system, a printing method, and a program.

### BACKGROUND ART

Conventionally, there has been known printing on a print medium using singling printing while moving the print head, which ejects ink in the inkjet system, alternately from left to right and right to left.

In this case, the ink ejected from the print head flows to the right of the ejection position when the print head moves from left to right (e.g., outward route), and to the left of the ejection position when the print head moves from right to left (e.g., inward route), so the ink landing position shifts from the target position. As a result, even though the print head position at the time of ink ejection is the same in the outward and inward routes, the ink landing positions do not overlap and the print quality deteriorates. Therefore, a correction value for the ink ejection timing is set so that the landing positions are the same.

However, if the print surface is a print medium containing curved surfaces, such as a fingernail, the spacing distance between the ink ejection surface of the print head and the print medium changes continuously in the main scanning direction.

For this reason, the general correction that deals with ink flow according to the print head movement direction assuming that the distance from the print head to the landing position is constant cannot eliminate the misalignment in the landing position between the ink ejected in the outward route and the corresponding ink ejected in the inward route.

In this regard, for example, JP 2018-1688 A discloses that when the spacing distance between the ink ejection surface of the print head and the print medium changes in the main scanning direction, the ink landing position misalignment due to the change in the spacing distance between the ink ejection surface and the print medium is suppressed by adjusting at least one of the ink ejection timing and ejection speed from the print head.

### SUMMARY OF INVENTION

### Problems to be Solved by Invention

However, the configuration described in JP 2018-1688 A does not achieve a good avoidance of misalignment of the ink landing position by taking into account the ink flow according to the movement direction of the print head and the misalignment of the ink landing position due to the change in the spacing distance between the ink ejection surface and the print medium that occur during singling printing.

The present invention was made in consideration of the above problems, and an object of the present invention is to provide a printing device, a terminal device, a printing system, a printing method, and a program that can realize good printing on a print medium having a curved surface.

### Solution to Problem

In order to solve the above problems, a printing device of the present invention is a printing device including:

an ejector that ejects a first droplet to a print medium partially having a curved surface while moving in a first direction, and ejects a second droplet corresponding to the first droplet to the print medium while moving in a second direction opposite to the first direction;

a correction level obtainer that obtains correction level information based on a distance between the print medium and the ejector and reference data that associates a correction level with each area obtained by dividing the print medium into multiple areas in a width direction; and an ejection controller that performs ejection control of at least one of ejection of the first droplet by the ejector and ejection of the second droplet by the ejector based on the correction level information obtained by the correction level obtainer so that a landing position on the print medium of the first droplet that the ejector ejects while moving in the first direction and a landing position of the second droplet that the ejector ejects while moving in the second direction substantially match each other.

### Effects of Invention

According to the invention, it is possible to achieve good printing on the print medium having a curved surface.

### BRIEF DESCRIPTION OF DRAWINGS

FIG. 1 is a perspective view showing an external configuration of a nail printing device according to the embodiments.

FIG. 2 is a main part block diagram showing the control configuration of the nail printing device in a first embodiment.

FIG. 3 is a view for explaining the ink ejection surface, reference surface, and ink landing position.

FIG. 4 is a view for explaining the ink ejection surface, reference surface, and ink landing position.

FIG. 5 is a view for explaining the ink ejection surface, reference surface, and ink landing position.

FIG. 6 is a graph showing the relationship between the distance between the reference surface and the ink landing surface and the ink landing gap.

FIG. 7A is a schematic diagram of a nail showing an example of correction level classification.

FIG. 7B is an explanation view for explaining the method of correcting data for printing when following the correction level classification shown in FIG. 7A.

FIG. 8 is an explanation view for explaining the factors required to determine the correction level.

FIG. 9A is an example of a table of correction levels, showing the items that are associated as correction levels.

FIG. 9B shows an example of a table of correction levels, with actual numerical examples for each item.

FIG. 10A is an explanation view showing an example of a nail pattern.

FIG. 10B is an explanation view showing an example of a nail pattern.

FIG. 10C is an explanation view showing an example of a nail pattern.

FIG. 11 is an example of a table showing examples of nail patterns and an example of area dividing by correction level for each example.

FIG. 12 is a flowchart showing printing processing in the first embodiment.

FIG. 13 is a flowchart showing singling data generation processing in the embodiment.

FIG. 14 is a main part block diagram showing the control configuration of a printing system in a second embodiment.

FIG. 15 is a flowchart showing printing processing in the second embodiment.

FIG. 16 is an explanation view for explaining a correction example of data for printing.

FIG. 17 is an explanation view for explaining a modification example of a correction example of data for printing.

FIG. 18 is an explanation view for explaining the method to correct misalignment.

### MODES FOR CARRYING OUT THE INVENTION

Hereinafter, an embodiment of a printing device, a terminal device, and a printing system including these devices according to the present invention will be described.

The embodiments described below have various limitations which are technically preferable for carrying out the present invention, but the scope of the present invention is not limited to the following embodiments and illustrated examples.

In the following embodiment, the printing device is a nail printing device which performs printing on a fingernail of a hand as a printing target. However, the printing target of the printing device in the present invention is not limited to a fingernail of a hand, and for example, a fingernail of a toe may be used as a printing target. In addition, the printing device of the present invention can be widely applied to those that perform printing to print media that partially have curved surfaces, and the printing target may be objects other than nails, such as nail tips and the surfaces of various accessories.

### First Embodiment

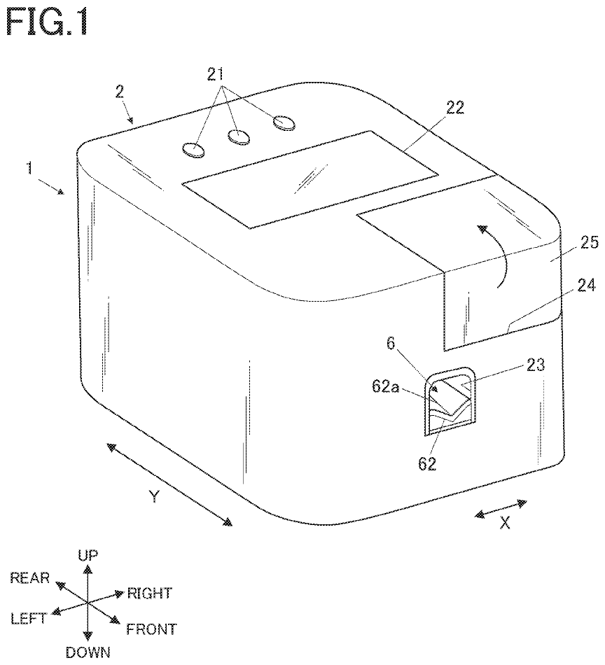

First, with reference to FIGS. 1 to 13, the case where the present invention is made by a single printing device is described as a first embodiment.

FIG. 1 is a perspective view showing an external configuration of a nail printing device that is a printing device in the embodiment.

In the following embodiment, the up and down, the left and right, and the front and rear are referred to as those shown in FIG. 1. The X direction and Y direction are referred to as those shown in FIG. 1.

The nail printing device 1 in the present embodiment includes a housing 2 which is formed in a substantially box shape, as shown in FIG. 1.

An operation unit 21 is set on the upper surface (top plate) of the housing 2.

The operation unit 21 is an operation unit for the user to perform various types of input.

The operation unit 21 is configured by including operation buttons for performing various types of input such as a power switch button to turn on the nail printing device 1, a stop switch button to stop the operation, and a printing start button to instruct to start printing, for example.

When the operation unit 21 is operated, an operation signal is output to a control device 30, and the control device 30 performs control according to the operation signal, to operate the components of the nail printing device 1.

If a display 22 described below is equipped with a touch panel type input section, the operation unit 21 may include a touch panel type input section.

A display 22 is provided on the upper surface (top plate) of the housing 2.

The display 22 is configured by including a liquid crystal display (LCD), an organic electroluminescence display or other flat displays, for example.

A touch panel may be integrally formed with the surface of the display 22 in the embodiment. In this case, the touch panel is configured to allow the user to make various inputs by touch operation of touching the surface of the display 22 with a fingertip or a special pen not shown in the drawings, and the touch panel type input section functions as the operation unit 21.

In the embodiment, the display 22 includes, for example, a nail image obtained by photographing a printing finger (not shown), which is a finger corresponding to the nail T to be printed (i.e., an image of the printing finger including an image of the nail T), images of an outline shape of the nail T included in the nail image and the range planned to be printed (printing area) in the nail T, a design selection screen for selecting a nail design to be printed on the printing area of the nail T, a thumbnail image for confirming the design, and an instruction screen for displaying various instructions, a notification screen, a warning screen, etc. are displayed as appropriate.

In addition, on the front side of the housing 2 (the front side in FIG. 1) and approximately in the center of the X-axis direction of the device (the X direction in FIG. 1, the left-right direction of the nail printing device 1), a finger insertion port 23 is formed. The finger insertion port 23 is an opening for inserting a finger during printing with the nail printing device 1. The finger insertion port 23 is provided at a position corresponding to the finger stage 6 described below. In the embodiment, it is possible to place one finger at a time on the finger stage 6, and the finger insertion port 23 is formed to a width (length in the X-axis direction) and height sufficient to allow a finger to be inserted into the device.

The size, etc. of the finger insertion port 23 is not limited to this, but can be set appropriately according to the size, shape, etc. of the finger stage 6.

In addition, an opening 24 is provided in a part of the housing 2 where the print head 41 can be replaced. The opening 24 is provided with a lid 25 that can be opened and closed by a hinge or the like not shown in the drawings. When the lid 25 is closed, the opening 24 is blocked to prevent dust, etc., from entering the inside of the device.

The opening 24 allows users to access the inside of the device from outside the device when the lid 25 is open.

The lid 25, which closes the opening 24, may be manually opened and closed by the user, or may be configured to open and close automatically by pressing a button or other device not shown in the drawings.

The position where the opening 24 is provided is the position where the print head 41 of the printing unit 40 (described below) can be moved to the corresponding position. In the embodiment, the opening 24 is formed on the upper right side of the device, as shown in FIG. 1. The position and size of the opening 24 can be set appropriately.

In other words, the print head 41 of the embodiment is configured so that it can be detached from the carriage 42 and replaced, and the opening 24 is formed at a position and size that allow the smooth attachment and detachment of the print head 41 and its removal from the device.

The device main body, which is not shown in the drawings, is housed inside the housing 2.

The device main body is configured by various components assembled on a base.

On the base and at the front side of the device, a finger stage 6 is provided at a position corresponding to the aforementioned finger insertion port 23 to place the printing finger inserted through the finger insertion port 23. Here, the printing finger is the finger corresponding to the nail T to be printed by the printing unit 40.

On the lower side of the finger stage 6, a placing member 62 is provided to place the belly portion of the printing finger inserted in the finger stage 6.

The placing member 62 supports the printing finger from below in the finger stage 6, and is made of, for example, a flexible resin.

The placing member 62 of the embodiment has a depression 62a that is depressed along the Y-axis according to the number of fingers that can be inserted into the finger stage 6 (see FIG. 1).

As a result, when the printing finger is placed on the placing member 62, the depression 62a receives the belly portion of the printing finger and prevents each printing finger from rattling in the left-right direction.

The placing member 62 may be configured to move up and down, in which case the height of the placing member 62 can be adjusted according to the thickness of the printing finger.

The back side of the finger stage 6 on the top surface is open so that the nail T of the printing finger inserted in the finger stage 6 can be exposed through this opening. In the embodiment, printing is performed by the printing unit 40 described below in the open area.

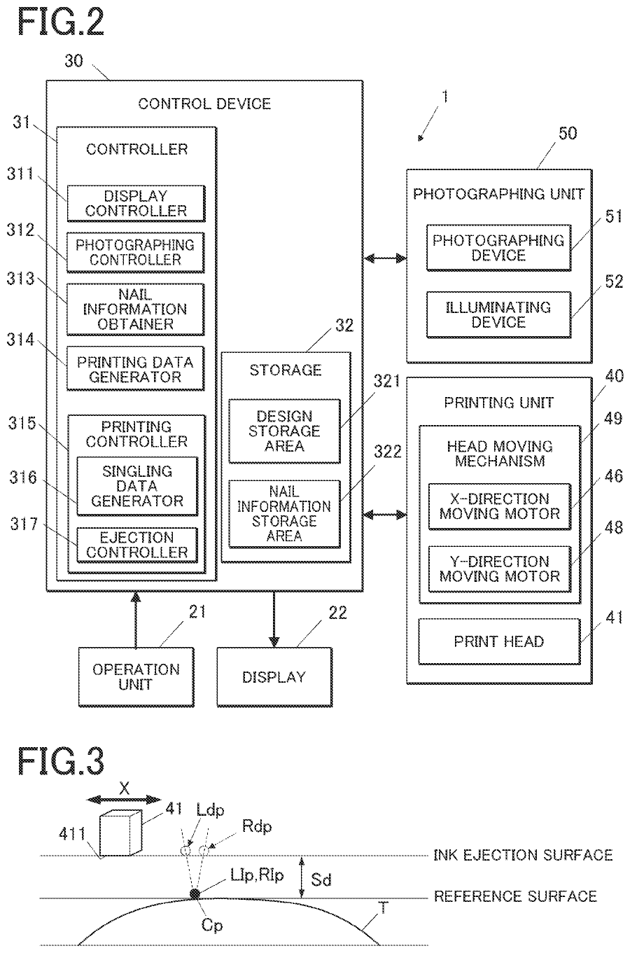

The printing unit 40 that performs printing on the nail T (surface of the nail T) of the printing finger, the photographing unit 50 that obtains photographed images (nail image including the nail T) of the printing finger including the nail T, and the like are provided inside the device main body (see FIG. 2).

The printing unit 40 prints on a print medium that partially has a curved surface, and in the embodiment prints on the surface of the nail T. The printing unit 40 includes a print head 41 supported by a carriage not shown or the like, a head moving mechanism 49 (see FIG. 2) for moving the print head 41 in the X-axis direction (X-axis direction in FIG. 1, left-right direction of the nail printing device 1) and Y-axis direction (Y-axis direction in FIG. 1, depth direction of the nail printing device 1, front-rear direction).

The head moving mechanism 49 consists of an X-direction moving motor 46, a Y-direction moving motor 48, etc. as a drive unit for moving the print head 41 in the X and Y directions as appropriate.

The printing unit 40 is connected to the printing controller 315 (see FIG. 2) of the control device 30 described below, and is controlled by the printing controller 315.

In this embodiment, the print head 41 is an ejector that, while moving above the nail T (i.e., above the nail surface) of the printing finger held in the finger stage 6, ejects ink onto the surface of the nail T to print the nail design.

The print head 41 ejects the first droplet while moving in the first direction (for example, from left to right in the main scanning X direction) against the surface of the nail T, which is a print medium partially having a curved surface, and ejects the second droplet corresponding to the first droplet against the surface of the print medium, nail T, while moving in the second direction (e.g., from right to left in the main scanning X direction), which is opposite to the first direction.

The print head 41 has the surface facing the surface of nail T as an ink ejection surface 411 including multiple nozzle openings to eject ink. The print head 41 is an inkjet type inkjet head that performs printing by making micro droplets of ink and directly spraying, from the ink ejection surface 411, the ink onto the surface of nail T.

The print head 41 is a cartridge-integrated type having inks of respective colors therein, and can eject ink of colors such as Y (YELLOW), M (MAGENTA), and C (CYAN), for example. The type of the color ink which can be ejected by the print head 41 is not limited to them. For example, the print head 41 may also include the ink of black (K), and be able to eject the ink of black (K). The configuration and the like of the print head 41 are also not limited to those shown in the embodiment. For example, the print head 41 may be configured separate from the cartridge.

The photographing unit 50 (see FIG. 2) includes a photographing device 51 and an illuminating device 52.

The photographing device 51 is, for example, a small-sized camera configured by including a solid imaging element which has approximately two million pixels or more and a lens, both of them are not shown in the drawings. The illuminating device 52 is an illuminating lamp of a white LED, for example.

The photographing unit 50 illuminates the nail T of the printing finger placed on the finger stage 6 with the illuminating device 52. The photographing unit 50 photographs the area corresponding to the nail T of the printing finger with the photographing device 51, and obtains the nail image (image of the printing finger including the image of nail T).

The photographing unit 50 is connected to a photographing controller 312 described below (see FIG. 2) of the control device 30 and controlled by the photographing controller 312.

The image photographed by the photographing unit 50 may be stored in a storage 32 described below.

FIG. 2 is a block diagram showing the main parts of the control configuration of the nail printing device in the embodiment.

As shown in FIG. 2, the nail printing device 1 includes the control device 30.

The control device 30 is a computer that includes: a controller 31 configured by including at least one processor such as a CPU (Central Processing Unit) not shown in the drawings; and a storage 32 configured by including a ROM (Read Only Memory), a RAM (Random Access Memory) (none of them shown in the drawings), and the like.

The control device 30 is set on a substrate or the like (not shown in the drawings) placed on the lower surface side of the top plate of the housing 2, for example.

The storage 32 stores various types of programs and data not shown in the drawings to operate the nail printing device 1.

To be specific, for example, the storage 32 stores in the ROM various programs such as a printing program for performing printing processing, and the controller 31 reads out these programs, loads them to the working area of RAM, and execute them, to integrally control the components of the nail printing device 1.

The storage 32 in the embodiment includes a design storage area 321 that stores nail design data, a nail information storage area 322 that stores the nail image data obtained by the photographing unit 50, and various data obtained by analyzing the nail image by an after-mentioned nail information obtainer 313. The data that the nail information obtainer 313 obtains by analyzing nail images include, for example, the outline of the area of nail T (coordinates indicating the outline shape of nail T, etc.), coordinates indicating the range of the printing area (the area where the nail design is printed according to the printing data) included in the area of nail T, the curvature of nail T (data indicating the degree of curvature), and the correction level information obtained by the nail information obtainer 313 as the correction level obtainer, etc. The data stored in storage 32 is not limited to those shown in the embodiment.

In a functional view, the controller 31 includes a display controller 311, a photographing controller 312, a nail information obtainer 313, a printing data generator 314, a printing controller 315, and the like. The functions as the display controller 311, photographing controller 312, nail information obtainer 313, printing data generator 314, printing controller 315, and the like are realized by cooperation between the CPU of the controller 31 and the programs stored in the ROM of the storage 32.

The display controller 311 controls the display 22 to display various types of display screens on the display 22.

For example, the display controller 311 controls the display 22 to display a design selection screen urging the user to select the nail design to be printed on the nail T. When nail designs are displayed on the design selection screen, the nail designs may be those stored in storage 32 or obtained from an external terminal device or a server device that provides cloud computing services, for example. It is preferable that the display controller 311 displays nail designs on the display 22 in sequence or in a list on the design selection screen.

In addition, the display controller 311 may cause the display 22 to display an image of the nail T with the nail design selected by the user superimposed on it, so that the user can check the finished image before the actual printing starts, and can re-select the nail design if the user does not like the design.

The display controller 311 may cause the display 22 to display various messages and instructions to the user.

The photographing controller 312 controls the photographing device 51 and the illuminating device 52 of the photographing unit 50, and controls the photographing device 51 to photograph a printing finger placed on the finger stage 6 to obtain the nail image including the image of nail T.

The data of the nail image obtained by the photographing unit 50 may be stored in the storage 32.

The nail information obtainer 313 identifies the range to be printed by the printing unit 40, such as the outline shape of the nail T of the printing finger (printing area).

The specific method by which the nail information obtainer 313 detects the printing area is not particularly limited. For example, the nail image obtained by photographing the nail T with a base coat of a different color from the nail T and finger (printing finger) is analyzed to detect the area where the base coat is applied and the detected area is set as the printing area.

In other words, when the nail T is unpainted, it is difficult to distinguish the nail T from the color of the surrounding skin, such as fingers. For this reason, the embodiment applies a base coat such as white color or white ink to the surface of the nail T in advance, and the nail information obtainer 313 analyzes the brightness, lightness, tint, etc. of the nail image to distinguish between the part with the base coat, etc. and the other part. Then, the nail information obtainer 313 detects the area where the base coat is applied as the range to be printed (the outline of the nail T).

The information used by the nail information obtainer 313 to identify the printing area for the nail T of printing finger is not limited to the nail image. For example, when a sensor or the like is installed to detect the area where the nail T is located, the information detected by the sensor may be used.

There is also nail information as the information obtained by the nail information obtainer 313. The nail information includes, for example, the outline of nail T (nail shape, XY coordinates of horizontal position of nail T, etc.), the inclination angle of the surface of nail T with respect to the XY plane (inclination angle of nail T, nail curvature), etc.

When the height of the nail T (vertical position of the nail T) can be obtained from the image taken by the photographing device 51, the height of the nail T is also included in the nail information.

The information obtained by the nail information obtainer 313, such as coordinates of the outlines that define the printing area, the coordinates of the outline of nail T, the curvature, and other information, is stored in the nail information storage area 322 of the storage 32.

In the embodiment, the nail information obtainer 313 functions as a correction level obtainer to obtain the correction level information corresponding to the distance (interval Sd in FIG. 3, etc.) between the surface of the nail T which is the print medium and the ink ejection surface 411 of the print head 41 which is the ejector.

In general, printing devices use the surface of the print medium (nail T in the embodiment) as the reference surface, and printing operation is performed by maintaining a constant distance (interval Sd) between the ink ejection surface of the print head and the reference surface. The printing operation is carried out by ejecting ink while moving the print head in the left-right direction. In this case, the inertia caused by the movement causes the ink to flow and land on the reference surface from an oblique direction. At this time, the correction value for the landing position of the ink droplet is set appropriately by adjusting the ink ejection timing, etc., so that the ink droplet ejected while moving from left to right and the ink droplet ejected while moving from right to left are both landed at the correct position on the reference surface, preventing the misalignment in landing position. This enables high-definition printing without misalignment.

In this regard, the nail printing device 1 of the embodiment prints on a print medium such as nail T, which partially has a curved surface, and as shown in FIG. 3, the reference surface is set at the highest part of the curved surface of the print medium, nail T (i.e., the highest part of nail T).

Therefore, when the ink droplets are landed on the reference surface, they are landed at almost the same position without misalignment.

In FIG. 3, the movement from left to right in the X direction is referred to as the movement in the “first direction”, and the ink droplet ejected while moving in this “first direction” is referred to as the “first ink droplet Ldp” (also referred to simply as the “first droplet Ldp” or “ink droplet Ldp”).

The ink droplet corresponding to the first droplet Ldp and ejected while moving in this “second direction”, which indicates the movement from right to left, is hereinafter referred to as “second ink droplet Rdp” (also simply referred to as “second droplet Rdp” or “ink droplet Rdp”).

As shown in FIG. 3, when the “first ink droplet Ldp”, which is ejected while moving in the “first direction”, is ejected from the ejection position (indicated by the solid circle in FIG. 3) for which control is made such that “first ink droplet Ldp” is landed at the position where the first ink droplet Ldp should originally land (target landing position Cp) and the “second ink droplet Rdp”, which corresponds to the first droplet Ldp and is ejected while moving in the “second direction” is ejected from the ejection position for which control is made such that the “second ink droplet Rdp” is landed at the position where the “second ink droplet Rdp” should originally land (target landing position Cp), the droplets are landed at almost the same positions on the reference surface without misalignment. In other words, the first droplet Ldp and the second droplet Rdp overlap at almost the same landing positions LIp, RIp.

However, the first droplet Ldp and the second droplet Rdp are adjusted such that the first droplet Ldp and the second droplet Rdp are landed at the correct landing position Cp in the reference surface as described above (i.e., the landing positions LIp and RIp are almost coincident with the landing position Cp).

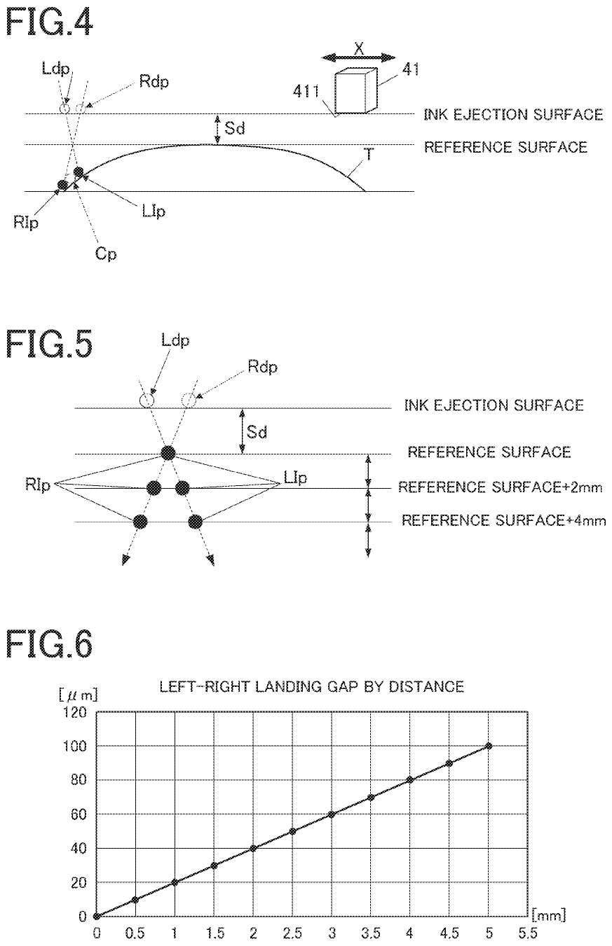

For this reason, if the distance between the reference surface and the ink ejection surface 411 becomes wider than the distance Sd, as shown in FIG. 4, the landing positions LIp and RIp are misaligned accordingly. In other words, the ink droplets that should originally be landed at the target landing position Cp shown by the dashed line and overlap each other are landed at different landing positions LIp, RIp, and the ink droplets do not overlap.

As shown in FIG. 5, this misalignment of the landing positions LIp and RIp becomes larger the further the landing surface of the first droplet Ldp and the second droplet Rdp is from the reference surface.

FIG. 6 shows an example of the degree of misalignment of the landing positions LIp and RIp. In FIG. 6, the horizontal axis is the gap amount (mm), from the reference surface, of the surface (landing surface) where the ink droplet is landed, and the vertical axis is the degree of gap (μm) of the landing positions LIp, RIp.

In FIG. 6, “0” means that the landing surface where the first droplet Rdp and the second droplet Rdp land is exactly on the reference surface. In this case, there is no gap between the landing positions of the first and second droplets, and high-definition printing with almost no misalignment can be achieved when the ink is ejected while moving left and right in the scanning direction (X direction).

However, the gap between the landing positions LIp and RIp increases as the landing surface moves away from the reference surface. In the example shown in FIG. 6, when the landing surface is 2 mm away from the reference surface, a gap of about 40 μm occurs. When the landing surface is 4 mm away from the reference surface, a gap of about 80 μm occurs.

For example, when printing at 600 dpi, one pixel (one dot) is approximately 42.3 μm. If the gap between landing positions LIp and RIp is 40 μm, the gap will be almost one pixel. If the landing surface is 4 mm away from the reference surface and the gap between the landing positions LIp and RIp is 80 μm, the gap will be almost two pixels.

Therefore, the nail information obtainer 313 as a correction level obtainer obtains the correction level information of the correction data to eliminate the landing position gap of the first droplet Ldp and the second droplet Rdp. The surface of nail T, which is the print medium of the printing device in the embodiment, has an arc-shaped curved surface in the width direction. Therefore, the curvature differs depending on where in the width direction of the nail T the position to be printed (the planned landing position of the ink droplet) is, and the distance (interval Sd) from the reference position (the position of the reference surface) also differs. Specifically, the depth is deeper toward the ends of the width direction of nail T, and the distance (interval Sd) from the reference position (the position of the reference surface) increases.

The correction level information is information that associates the position to be printed with the degree of correction that needs to be made.

In the embodiment, when the singling data generator 316 described below generates the singling data, correction is made to eliminate the gap of the landing position in the left-right direction, and the correction level information is referred to by the singling data generator 316 when generating the data.

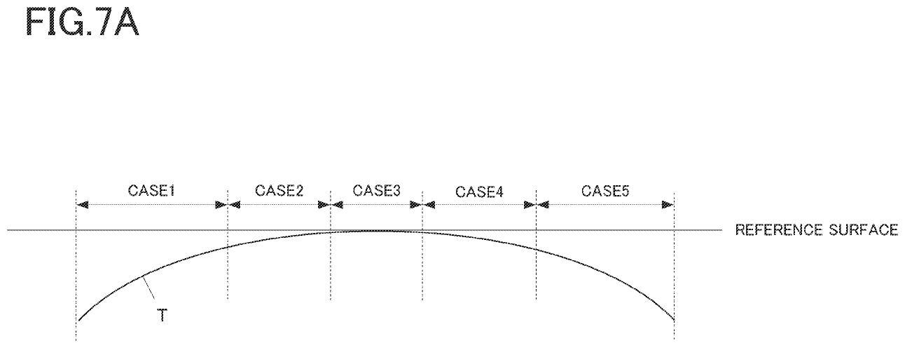

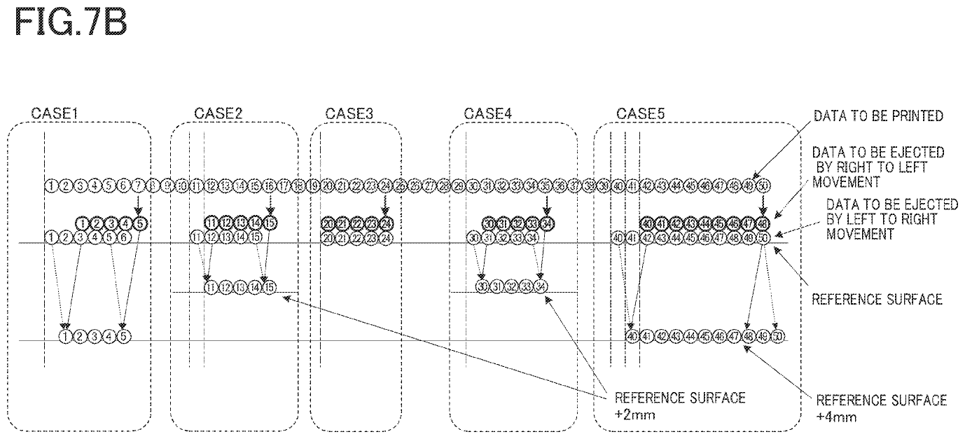

FIG. 7A is a schematic diagram of a nail showing an example of correction level classification, and FIG. 7B is an explanation view showing an example of correction using correction data according to correction level information obtained by a nail information obtainer as a correction level obtainer when following the correction level classification shown in FIG. 7A.

FIG. 7B shows the array of data in the width direction of nail T, in the horizontal direction of the nail T with correction level classification as shown in FIG. 7A, and schematically shows, in the vertical direction, the distance of the landing surface of the ink droplet from the reference surface (interval Sd). In the example shown in the figure, data for 50 pixels (circled numbers 1 to 50) are prepared as data to be printed on one line in the nail width direction of nail T.

In FIG. 7B, the number circled with a thin line means the printing data of the ink droplet (“the first ink droplet Ldp”) that is ejected while the print head 41 moves from left to right (movement in the “first direction”). The bold circled number means the printing data of the ink droplet (“second ink droplet Rdp”) to be ejected while the print head 41 moves from right to left (movement in the “second direction”).

Here, there is shown, as an example, a case where the landing position of the ink droplet (“first ink droplet Ldp”) to be ejected while the print head 41 moves from left to right (movement in the “first direction”) is the reference, and only the printing data of the ink droplet (“second ink droplet Rdp”) to be ejected while the print head 41 moves from right to left (movement in the “second direction”) is corrected to match the landing position of the first ink droplet Ldp.

For example, in FIG. 7A and FIG. 7B, “CASE3” means processing around the center of the width direction of nail T.

In the area shown in “CASE3”, the landing surface of the ink droplet is almost coincident with the reference surface. In such an area, after the ink droplet (“first ink droplet Ldp”) is ejected while moving in the “first direction”, the ink droplet (“second ink droplet Rdp”) is ejected while moving in the “second direction” without any correction (without shifting from the original printing position). Without performing correction, the “first ink droplet Ldp” and the “second ink droplet Rdp” overlap and land at the same landing position and misalignment does not occur.

For example, in FIG. 7A and FIG. 7B, the areas shown in “CASE2” and “CASE4” are the areas adjacent to “CASE3” in the width direction of nail T and indicate the processing in the area where the landing surface is lower than the reference surface due to the curved shape of the nail.

In the areas shown in “CASE2” and “CASE4”, the landing surface of the ink droplet is about 2 mm away from the reference surface. In these areas, as the landing surface becomes deeper in the height direction of the nail T, the data is corrected to eject the printing data of one pixel ahead of the original printing position as the printing data to eject the “second ink droplet Rdp”.

As a result, a shift by one pixel appears to be generated on the reference surface, but in the actual position (landing surface) where the ink droplets Ldp, Rdp are landed at 2 mm deeper than the reference surface, the “second ink droplet Rdp” is landed at the position overlapping the “first ink droplet Ldp”, which is the state of having no misalignment.

For example, in FIG. 7A and FIG. 7B, “CASE1” and “CASE5” are the areas at the end of the nail T in the width direction, and indicates the processing in the areas having the largest nail curve and the lowest landing surface with respect to the reference surface.

In the areas shown in “CASE1” and “CASE5”, the landing surface of the ink droplet is about 4 mm away from the reference surface. In these areas, as the landing surface becomes deeper in the height direction of the nail T, the data is corrected to eject the printing data of two pixels ahead of the original printing position as the printing data to eject the “second ink droplet Rdp”.

As a result, a shift by two pixels appears to be generated on the reference surface, but in the actual position (landing surface) where the ink droplets Ldp, Rdp are landed at 4 mm deeper than the reference surface, the “second ink droplet Rdp” is landed at the position overlapping the “first ink droplet Ldp”, which is the state of having no misalignment.

In this way, since the landing surface of the ink droplet is much lower than the reference surface at the ends of nail T, if the data two pixels ahead is ejected as described above, there is a concern that the data to be printed at the very ends of nail T may be insufficient.

Therefore, it is preferable to prepare the data to be printed by expanding the outline of nail T by two pixels in the nail width direction in advance. This way, there will be no shortage of data to be printed at the very end of nail T even if printing is performed while shifting the data ahead by two pixels.

The method by which the nail information obtainer 313 obtains the correction level information to make the above correction is not limited.

For example, the nail information obtainer 313 may obtain the correction level from the nail width information.

In other words, the nail information obtainer 313 can obtain the nail width W from the nail image. Therefore, the nail T can be divided into multiple areas in the width direction according to the nail width W, and the correction level may be associated with each area.

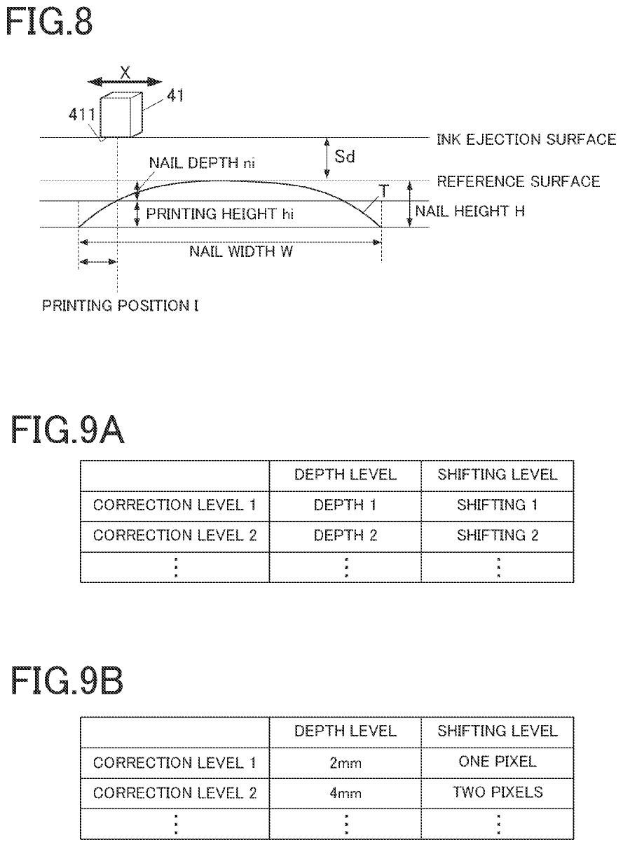

As shown in FIG. 8, when the nail width W is detected, some tendency can be inferred from the general tendency of human nail shape and various statistical data, the some tendency being, for example, in the case of wide nails, a certain amount of the wide area in the center is flat with relatively little curvature, and a certain percentage of the end is strongly curved. For this reason, the area division of the correction levels may be determined in advance by default according to the nail width W.

In this case, it is preferable to prepare a table that sets the depth level of nail T corresponding to each correction level and the shifting level at each depth level.

FIG. 9A shows an example of the table structure.

For example, in the case where the area is divided into the area that is relatively flat and does not require correction and the area that requires correction, FIG. 9A shows, as an example, a case where the area that requires correction is further divided into “correction level 1” and “correction level 2” as level classification.

FIG. 9B shows examples of the specific depth levels in “correction level 1” and “correction level 2” and the shifting level in each case. The depth level is the distance from the reference surface of the ink landing position in the area that is about to be printed. The further away from the reference surface, the more likely it is that left-right misalignment will occur, and the amount of correction (shifting amount) needs to be increased.

In the example shown in FIG. 9B, in the case of “correction level 1”, the depth level is 2 mm, and the shifting amount of pixel to be shifted by the correction is one pixel. In the case of “correction level 2”, the depth level is 4 mm, and the shifting amount of pixel to be shifted by the correction is two pixels.

The correction level is not limited to the case where the area is divided into three levels: no correction, “correction level 1”, and “correction level 2”. For example, it is possible to divide the area into more detailed areas and change the correction level for each. The area may also be divided into two levels: with correction and without correction.

In order to divide the correction levels more precisely, for example, the nail information obtainer 313 may obtain the curved surface shape in the nail width direction based on the nail image or other data obtained by the photographing unit 50, divide the nail patterns into multiple levels according to the obtained curvature, and associate a correction level with each nail pattern.

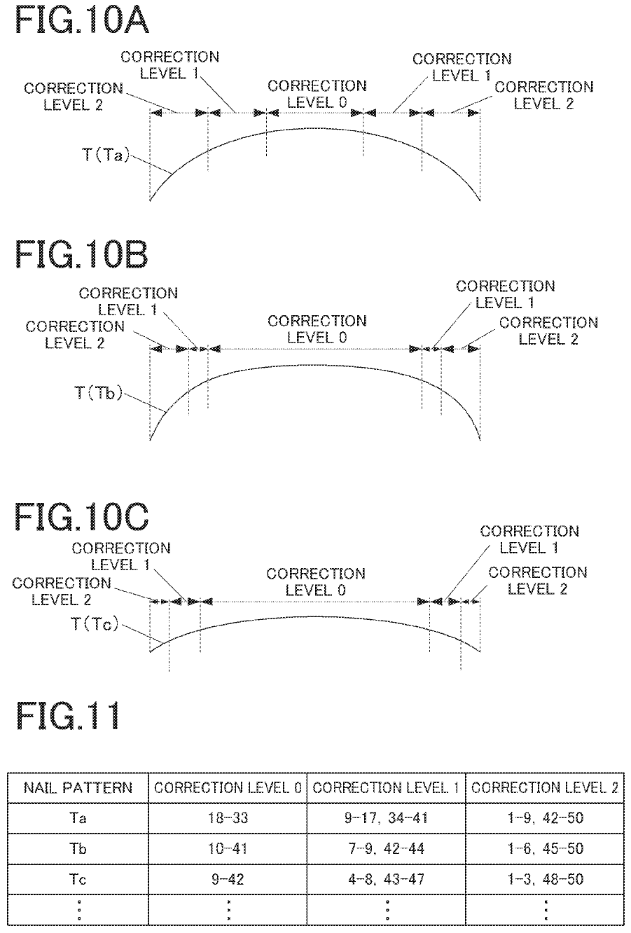

For example, FIG. 10A through FIG. 10C illustrate three types of patterns of nail T.

FIG. 11 shows an example of each area of the correction level for each nail pattern shown in FIGS. 10A to 10C. The numerical values of 1 to 50 used in the classification in FIG. 11 are based on the example of FIG. 7, which provides data for 50 pixels in the nail width direction.

FIG. 10A is an arc shape with a gentle slope throughout, and there is not much flat area in the center of the nail width direction. In this case, the “correction level 0 (i.e., no correction),” “correction level 1,” and “correction level 2” areas are divided in a near equal distribution.

On the other hand, in FIG. 10B, a wide area in the center of the nail width direction is a flat area, and both ends are greatly depressed. In this case, there is a wide area of “correction level 0 (i.e., no correction)”, small areas of “correction level 1”, and areas of “correction level 2” at both ends that requires a large correction.

FIG. 10C is generally flat and does not have much area of large curvature. In this case, there is a large area of “correction level 0” (i.e., no correction) and almost no area of “correction level 2”.

When the nail printing device 1 performs curved surface correction according to the curvature of nail T, the nail printing device 1 may have such a table as reference data for determining the level of curved surface correction. In this case, the reference table prepared for curved surface correction may be referred to also as a reference table for setting the correction level for generating singling data.

The tables for classifying nail patterns are not limited to the three types illustrated here, and may be more or less than these. In addition, the table shown in FIG. 11 as a reference table for determining the areas of correction levels shown in FIG. 9A and FIG. 9B may be provided with a table for any one of the nail patterns shown in FIG. 10A through FIG. 10C. For example, a single nail pattern with a shape that is common in general nail T may be registered in the device. Also, when the user selects the one that the user thinks is closest to the user's own nail T from among multiple presented nail patterns and registers it in the device, this may be registered as a reference table like FIG. 11.

When singling data is generated using the tables shown in FIG. 9A and FIG. 9B, or the tables shown in FIGS. 10A through 10C, the user name and finger type, etc. may be stored so as to be associated with the selected table.

In this way, the same table can be used to perform the same process when printing on the same user's nail T of the same finger, thereby eliminating the processing time to obtain the correction level and quickly generating singling data that is more suitable for the user's nail T.

The printing data generator 314 generates printing data corresponding to the outline shape, etc. of the nail T obtained by the nail information obtainer 313.

Specifically, when the outline and area of nail T are set (specified) by the nail information obtainer 313, the printing data generator 314 cuts the nail design data (original data) according to the area of nail T, adjusts the shape and size as appropriate, and then generates the printing data.

If nail information such as the curvature of the nail T is detected by the nail information obtainer 313, the printing data generator 314 takes this nail information into account and makes the necessary corrections such as curved surface correction, and generates the printing data for the printing unit 40 to print on the printing area from the nail design data (original data).

The printing controller 315 is a controller that controls the head moving mechanism 49 (X-direction moving motor 46 and Y-direction moving motor 48, etc., which constitute the head moving mechanism 49), the print head 41 which is the ejector, etc. of the printing unit 40.

The printing controller 315 in the embodiment includes a singling data generator 316 and an ejection controller 317.

The singling data generator 316 is a printing information generator that generates printing information for controlling the ejection of the print head 41 based on the correction level information obtained by the nail information obtainer 313 which is the correction level obtainer. The singling data generator 316 generates data (singling data) for one main scanning line for each scan by the print head 41 for the printing data generated by the printing data generator 314.

In the embodiment, the singling data generator 316 refers to the correction level information of the nail T to be printed obtained by the nail information obtainer 313 as the correction level obtainer, makes appropriate corrections to the data that requires correction, and generates the singling data according to the printing position.

The specific method of generating the singling data will be described later.

The ejection controller 317 controls the ejection of the print head 41, which is the ejector of the printing unit 40, to print the nail design on the surface of the print medium, nail T, according to the data generated by the singling data generator 316 (singling data based on printing data).

The specific printing processing by the printing controller 315 is described later.

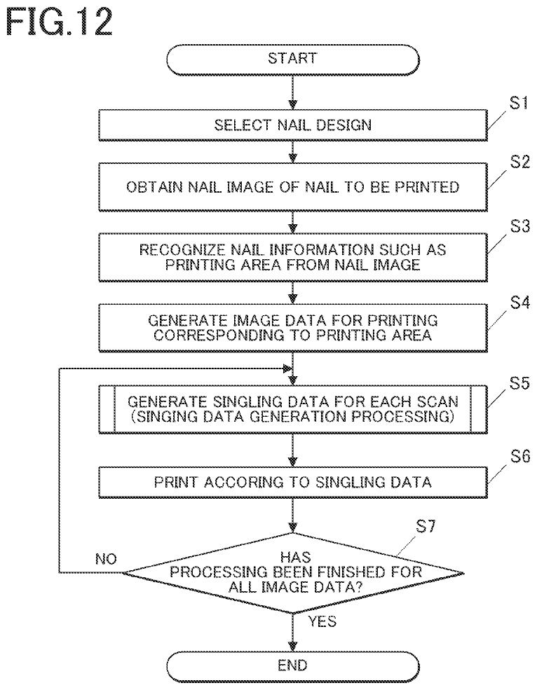

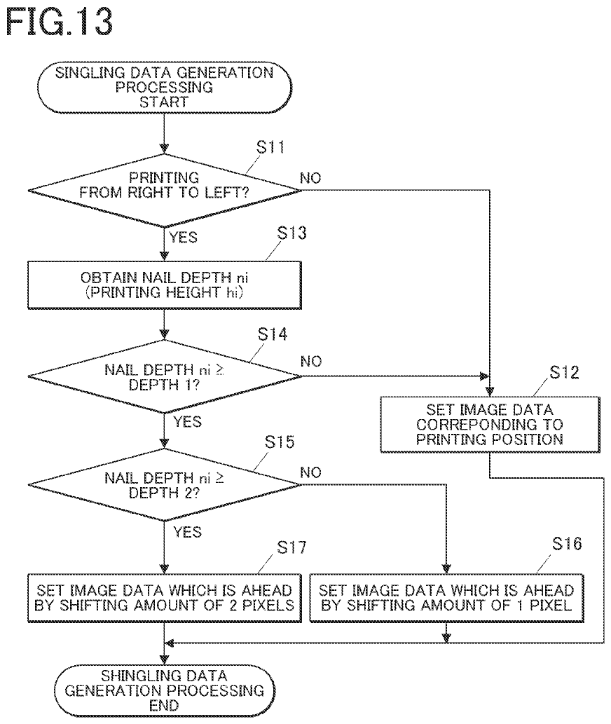

Next, referring to FIG. 12 and FIG. 13, the printing method of the nail printing device 1 of the embodiment will be described.

FIG. 12 is a flowchart showing the outline of the printing processing in the embodiment.

When the power of the embodiment's nail printing device 1 is turned on, for example, a message instructing the user to select a nail design appears on the display 22. The user selects the nail design to be printed on the nail T by operating the operation unit 21, touch panel or the like.

Thus, an operation signal is sent to the control device 30, and the desired nail design is selected as the nail design to be printed on the nail T, as shown in FIG. 12 (Step S1).

When a nail design is selected by the user, the controller 31 (display controller 311) applies a base coat (or white ink if white is included) to the nail T to be printed, and then displays an instruction screen, on the display 22, to instruct the user to insert said nail T (and its printing finger) into the finger stage 6 of the nail printing device 1 to prompt the user to set the printing finger.

When the printing finger is set on the finger stage 6, the controller 31 causes the photographing unit 50 to photograph the printing finger including the nail of the printing finger to obtain the nail image (Step S2).

When the nail image is obtained, the nail information obtainer 313 performs image analysis on the nail image and specifies the outline shape (printing area) of the nail. Specifically, the nail information obtainer 313 obtains the XY coordinates of the outline that defines the printing area (Step S3).

In addition, the nail information obtainer 313 obtains other nail information such as the curvature of the nail T based on the nail image.

Furthermore, the nail information obtainer 313 obtains the correction level information of the nail T as a correction level obtainer. For example, the nail information obtainer 313 judges whether the nail to be printed is close to any of the nail patterns shown in FIG. 10A to FIG. 10C based on the nail information such as the curvature and the width of the nail T. The nail information obtainer 313 reads out the area classification of correction level of the corresponding nail pattern from FIG. 11, and furthermore, obtains the shifting level for each correction level. In this way, the nail information obtainer 313 obtains the correction level information such as the position of nail T and the number of pixels to be shifted when printing the position.

The XY coordinates of the outline of the printing area, the Y coordinate Na1 of the nail tip side end, the Y coordinate Nb1 of the root side end, and other various information obtained by the nail information obtainer 313 are stored in the nail information storage area 322. After the various nail information is obtained by the nail information obtainer 313, the printing data generator 314 fits the nail design to the printing area and generates the printing data with appropriate corrections (Step S4).

Once the printing data is generated, the singling data generator 316 generates the singling data based on the printing data (Step S5).

Specifically, as shown in FIG. 13, the singling data generator 316 first determines whether or not the next planned printing is in the main scanning direction from right to left (i.e. (i.e., the “second direction”) (step S11).

In the embodiment, the main scanning direction is based on printing in the direction from left to right (i.e., the “first direction”). For this reason, the printing is fixed without any correction for the printing in the moving direction, and the correction is made only for the printing in the corresponding opposite direction (i.e., the “second direction”) so that the ink droplet is landed at the same position as the ink droplet ejected and landed in the printing in the “first direction”.

Therefore, if the printing is not in the main scanning direction from right to left (“second direction”) (i.e., the printing is in the “first direction”, Step S11; NO), the image data corresponding to the present printing position is set as it is (without correction) as singling data (Step S12), and the singling data generation processing is finished.

On the other hand, if the printing is in the main scanning direction from right to left (“second direction”) (Step S11; YES), the singling data generator 316 obtains the nail depth ni (or printing height hi) of the printing position in the printing (Step S13).

Then, the singling data generator 316 determines whether or not the nail depth ni is the same as or greater than the depth level “depth 1” that is associated with the correction level 1 (Step S14). If the nail depth ni is smaller than “depth 1” (Step S14; NO), then no correction is required, and the singling data generator 316 sets the image data corresponding to the printing position as it is (without correction) as singling data (Step S12), and ends the singling data generation processing.

On the other hand, if the nail depth ni is equal to or greater than “depth 1” (Step S14; YES), then it is further determined whether the nail depth ni is equal to or greater than the depth level “depth 2” that is associated with correction level 2 (Step S15). If the nail depth ni is smaller than “depth 2” (Step S15; NO), correction level 1 is applied, and the singling data generator 316 sets the image data which is ahead by the shifting amount of one pixel as singling data (Step S16), and ends the singling data generation processing.

On the other hand, if the nail depth ni is equal to or greater than “depth 2” (Step S15; YES), correction level 2 is applied, and the singling data generator 316 sets the image data which is ahead by the shifting amount of two pixels as singling data (Step S17), and ends the singling data generation processing.

Returning to FIG. 12, when the singling data is generated and set, the ejection controller 317 of the printing controller 315 controls the ejection of the print head 41 to perform printing by ejecting ink from the print head 41, which is the ejector, based on the singling data (Step S6). The controller 31 determines whether or not the processing of all image data for nail T has been finished (Step S7), and if the processing has not been finished (Step S7; NO), returns to Step 5 and repeats the process.

On the other hand, if the processing has been finished for all image data (Step S7; YES), the controller 31 ends the printing processing.

As described above, according to the embodiment, there are provided: a print head 41 as an ejector that ejects a first droplet to a nail T as a print medium partially having a curved surface while moving in a first direction (for example, from left to right) and ejects a second droplet corresponding to the first droplet to the nail T while moving in a second direction (for example, from right to left) opposite to the first direction; a nail information obtainer 313 as a correction level obtainer that obtains correction level information corresponding to the distance between the nail T and the print head 41 (ink ejection surface 411 of the print head 41); and an ejection controller 317 that performs ejection control of at least one of ejection of the first droplet by the print head 41 and ejection of the second droplet by the print head 41 based on the correction level information obtained by the nail information obtainer 313 so that the landing position on the nail T of the first droplet ejected by the print head 41 while moving in the first direction and the landing position of the second droplet ejected by the print head 41 while moving in the second direction substantially match each other.

This prevents the ink droplet landing position from shifting in the left-right direction when printing on the nail T while reciprocating in the left-right direction (nail width direction), thus enabling high-definition image formation.

In the embodiment, the ejection controller 317 controls only the ejection of the second droplet by the print head 41 based on the correction level information obtained by the nail information obtainer 313 so that the landing position of the second droplet ejected while the print head 41 moves in the second direction (for example, from right to left) substantially matches the landing position on the nail T of the first droplet ejected while the print head 41 moves in the first direction (for example, from left to right).

By correcting only the landing position of the second droplet ejected while the print head 41 moves in the second direction (e.g., from right to left), the burden of calculation processing can be reduced, the processing time can be shortened, and the control device 30 can be made relatively simple.

In the embodiment, the ejection controller 317 performs the ejection control of the first droplet and the second droplet by the print head 41 by referring to first printing data corresponding to the first droplet and second printing data corresponding to the second droplet, and the ejection controller 317 changes the first printing data corresponding to the first droplet or the second printing data corresponding to the second droplet based on the correction level information obtained by the nail information obtainer 313 so that the landing position on the nail T of the first droplet ejected by the print head 41 and the landing position on the nail T of the second droplet ejected by the print head 41 substantially match each other.

For example, when shifting the landing position in the left-right direction by changing the ink ejection timing, it is necessary to take high-frequency response to eject the ink one or two pixels earlier than other areas at the end of the nail width. In this regard, the embodiment adjusts the landing position by correcting the printing data itself. Therefore, there is no need to control to perform the high-frequency response, and the process to avoid misalignment of the landing position in the left and right directions can be simplified.

In the embodiment, the ejection controller 317 changes the second printing data corresponding to the second droplet based on the correction level information obtained by the nail information obtainer 313 so that the second droplet substantially matches the landing position on the nail T of the first droplet by the print head 41.

By correcting only the landing position of the second droplet ejected while the print head 41 moves in the second direction (e.g., from right to left), the burden of calculation processing can be reduced, the processing time can be shortened, and the control device 30 can be made relatively simple.

In the embodiment, the first printing data is printing data in which the timing to eject the first ink is determined for each printing pixel based on a reference distance Sd between the nail T and the print head 41 (ink ejection surface 411 of the print head 41), the second printing data is printing data in which the timing to eject the second ink is determined for each printing pixel based on a reference distance Sd between the nail T and the print head 41 (ink ejection surface 411 of the print head 41). The ejection controller 313 shifts, by one pixel or more, the timing to eject the first droplet by the first printing data or the second droplet by the second printing data based on the correction level information obtained by the nail information obtainer 313.

For example, if the left and right landing positions have a gap of about 40 μm, a gap of almost one pixel will occur, and in this case, the gap is the level visible to the human eye.

In this regard, by shifting the ejection timing by one pixel or more, it is possible to prevent the printing quality from deteriorating due to the misalignment of the landing position.

In the embodiment, the nail information obtainer 313 may obtain the correction level information from reference data in which the nail T is divided into multiple areas in the width direction and the correction level is associated with each area.

In this case, the correction level information can be obtained easily and quickly, reducing the burden of the calculation process.

In this case, the reference data is a table that divides the nail T into multiple areas in the width direction and associates the correction level with each area, for example. Multiple types of reference data may be prepared according to the degree of curvature of the curved surface of nail T.

In this way, it is possible to obtain correction level information that is more appropriate to the user's nail T, and appropriate corrections can be made.

In the embodiment, based on the correction level information, the ejection controller 317 may perform the ejection control of the print head 41 so as to eject the droplet from before the ejection position in the movement direction of the print head 41, the ejection position being a position where the droplet should originally be ejected from the print head 41.

In this way, it is possible to eliminate the misalignment in printing position as well.

### Second Embodiment

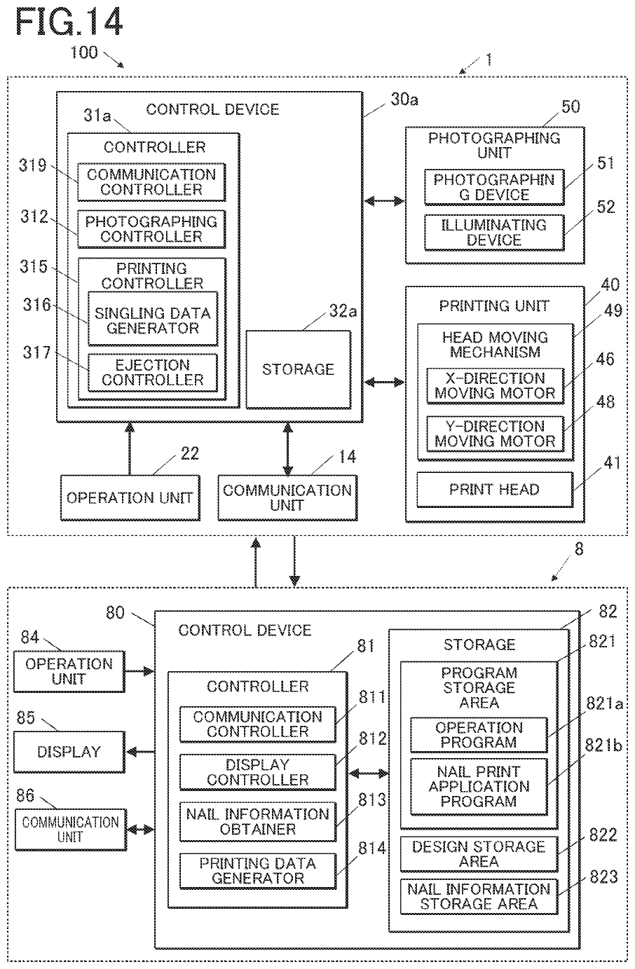

Next, with reference to FIG. 14, the case where the present invention is a printing system 100 formed by a nail printing device 1 which is a printing device and a terminal device 8 is described as a second embodiment.

FIG. 14 is a block diagram showing the main part configuration of the printing system in the embodiment.

As shown in FIG. 14, the printing system 100 in the embodiment is configured by the nail printing device 1 and the terminal device 8. The nail printing device 1 includes a nearly same configuration as that of the first embodiment except for the control configuration. Thus, in the embodiment, the explanation is made focusing especially on the points that differ from the first embodiment.

As shown in FIG. 14, the nail printing device 1, which constitutes the printing system 100 of the embodiment, has an operation unit 22, a communication unit 14, a printing unit 40, a photographing unit 50, and a control device 30a that includes a controller 31a and a storage 32.

The operation unit 21, the printing unit 40 and the photographing unit 50 are the same as the printing unit 40 and the photographing unit 50 shown in the first embodiment, so the same parts are marked with the same signs and the explanation is omitted.

In the embodiment, only the terminal device 8 includes a display 85, but the nail printing device 1 may also include the display in the embodiment. In this case, the display of the nail printing device 1 and the display 85 of the terminal device 8 may both display the same contents according to control by the control device 30a of the terminal device 8, or they may display different contents according to control by the control devices 30 and 30a, respectively.

The communication unit 14 included in the nail printing device 1 of the embodiment is a wireless communication module or the like that can communicate with the terminal device 8, and is configured to send and receive information.

The communication between the nail printing device 1 and the terminal device 8 may use network lines such as the Internet, for example, or wireless communication based on short-range wireless communication standards such as Bluetooth (registered trademark) or Wi-Fi, for example. In the case of communication via a network, the network used for communication may be any type of line. The communication between the nail printing device 1 and the terminal device 8 is not limited to wireless communication, but can also be configured to enable the transmission and reception of various data between the nail printing device 1 and the terminal device 8 via a wired connection.

It is sufficient that the communication unit 14 is capable of communicating with the terminal device 8, and the unit that matches the communication standard of the communication unit 86 of the terminal device 8 is applied as the communication unit 14.

The communication unit 14 is connected to the communication controller 316 of the control device 30 and is controlled by the communication controller 316.

The communication controller 316 controls the operation of the communication unit 14. In the embodiment, the communication controller 316 controls the communication with the terminal device 8, to receive the printing data, etc. when the printing data, etc. is sent from the terminal device 8.

The other configuration of the nail printing device 1 is the same as that of the first embodiment, so the description thereof is omitted.

The terminal device 8 forming the printing system 100 in the embodiment includes, an operation unit 84, a display 85, a communication unit 86, and a control device 80, etc.

The terminal device 8 is a portable terminal device such as a smart phone, for example. The terminal device 8 is not limited to a smart phone. For example, the terminal device 8 may be a tablet-type personal computer (hereinafter referred to as “PC”), a notebook PC, a stationary PC, or a terminal device for games, etc.

The operation unit 84 allows various inputs, settings, etc. to be made in response to user operations, and when the operation unit 84 is operated, the input signal corresponding to the operation is sent to the controller 81. In the embodiment, a touch panel is integrally provided on the surface of the display 85, and the user can also perform various input and setting operations by touching the touch panel.

The touch panel configured in the display 85 displays various display screens according to the control by the display controller 812 described below.

The operation unit 84 that performs various operations such as inputting and setting is not limited to the touch panel. For example, various operation buttons, keyboard, pointing device, etc. may be provided as the operation unit 84.

In the embodiment, when the user operates the operation unit 84, the terminal device 8 outputs various instructions such as the start of printing to the nail printing device 1, and the terminal device 8 also functions as the operation unit of the nail printing device 1.

By operating the operation unit 84, the user can select the nail design to be printed on the nail T.

The display 85 is composed of, for example, a liquid crystal display (LCD: Liquid Crystal Display), an organic electroluminescent display, or other flat display.

A touch panel for various inputs may be integrally configured on the surface of the display 85. In this case, the touch panel functions as the operation unit 84.

In the embodiment, nail designs which are input and selected by the user from the operation unit 71, various guidance screens, warning display screens, etc. can be displayed on the display 85.

The communication unit 86 is capable of transmitting printing data to the nail printing device 1. In addition, when various data such as a nail image and a printing area which is a result of analysis of the nail image are transmitted from the nail printing device 1, the communication unit 86 receives the data. The communication unit 86 is equipped with a wireless communication module that can communicate with the communication unit 14 of the nail printing device 1.

As mentioned above, the communication between the nail printing device 1 and the terminal device 8 may be any communication able to send and receive data mutually, and as the communication unit 86, a communication unit that matches the communication standard of the communication unit 14 of the nail printing device 1 is applied.

As shown in FIG. 14, the control device 80 of the terminal device 8 in the embodiment is a computer that includes: a controller 81 configured by including a processor(s) such as a CPU (Central Processing Unit) not shown in the drawings; and a storage 82 configured by including a ROM (Read Only Memory), a RAM (Random Access Memory) (not shown in the drawings), and the like.

For example, flash memory of a non-volatile storage element such as NAND FLASH memory can be applied as the ROM that constitutes the storage 82. For example, a memory chip such as DDR can be applied as the RAM.

The storage 82 stores various programs, various data, etc. for operating each part of the terminal device 8.

Specifically, the program storage area 821 in the embodiment, which consists of the ROM, etc., includes an operation program 821a for integrally controlling each part of the terminal device 8, as well as various programs such as a nail print application program 821b (hereinafter, referred to as “nail print AP” for performing nail printing using the nail printing device 1. The control device 80 loads these programs in the working area of RAM, for example, and executes them to control the terminal device 8.

In the storage 82 in the embodiment, there are provided a design storage area 822 that stores nail design data, a nail information storage area 823 that stores the image of nail T (nail image), the printing area (i.e., the information that specifies the area where the base coat is applied in the nail image) that is the result of analysis of the nail image, and the information on the position and range of nail T (nail information), etc. when they are sent from the nail printing device 1, etc.

The nail design stored in the design storage area 822 may be an existing design prepared in advance, or a design created by the user. The nail design may also be obtained from external networks not shown in the drawings.

The controller 81 of the terminal device 8 includes a communication controller 811, a display controller 812, a nail information obtainer 813, a printing data generator 814, and the like, when viewed functionally. These functions as the communication controller 811, display controller 812, nail information obtainer 813, printing data generator 814, etc. are realized by the cooperation between the CPU of controller 81 and the program stored in the program storage area 821 of the storage 82. The functions provided by the controller 81 of the terminal device 8 are not limited to them, and various other functional parts may be provided.

The communication controller 811 controls the operation of the communication unit 86. In the embodiment, the communication controller 811 controls the communication with nail printing device 1, and sends printing data corresponding to the printing area of each nail T to the nail printing device 1. When the nail printing device 1 sends the nail image or nail information data, the communication controller 811 controls the communication unit 86 to receive the data.

The display controller 812 controls the display 85 to display various display screens on the display 85.

In the embodiment, the display controller 812 causes the display 85 to display a design selection screen that prompts the user to select a nail design to be printed on the nail T, for example. When displaying the design selection screen, it is preferable that the display controller 812 displays the nail designs stored in the design storage area 822 sequentially or in a list on the display 85.

In addition, the display controller 812 may cause the display 72 to display an image having the nail design selected by the user superimposed on the image of the nail T, so that the user can check the finished image before the actual printing starts, and can re-select the nail design if the user does not like the nail design.

In addition, the display controller 812 may display messages and various instructions to the user on the display 85.

The nail information obtainer 813 detects various nail information such as the outline shape (printing area) of the nail T and the curvature of the nail T by image analysis of the nail image obtained by the photographing unit 50 of the nail printing device 1.

In other words, in the embodiment, the photographing unit 50 of the nail printing device 1 photographs the printing finger including the nail T before printing, and when the nail image is obtained, the data of the nail image is transmitted to the terminal device 8 through the communication unit 86. The nail information obtainer 813 detects the painted area of base coat or the like from the nail image as the outline shape (printing area) of the nail T.

In the embodiment, the nail information obtainer 813 also functions as a correction level obtainer to obtain correction level information to determine the correction level of the printing data.

The storage 82 may store various tables, etc. (see FIG. 9A, FIG. 9B and FIG. 11 in the first embodiment) for the nail information obtainer 813 to obtain the correction level information. In this case, the nail information obtainer 813 obtains the correction level information while referring to the tables as appropriate.

When the outline shape (printing area) of the nail is identified by the nail information obtainer 813, and various nail information, correction level information, etc. are detected, the communication controller 811 sends this information to the nail printing device 1.

The method by which the nail information obtainer 813 obtains the correction level information as a correction level obtainer is the same as the method in the first embodiment, and thus its description is omitted.

When the outline shape (printing area) of nail T is detected, the printing data generator 814 cuts out the nail design data (original data) so that it corresponds to the printing area, and generates printing data by fitting it to the printing area.

In the embodiment, the nail information is detected by the nail image analyzer 313, and the detection result is sent to the terminal device 8 via the communication units 14 and 86.

Specifically, the nail information includes the shape of nail T (the outline shape of nail T), the curvature of nail T, etc. The printing data generator 813 takes this nail information into account and makes the necessary corrections such as curved surface correction as appropriate, to generate the printing data for the printing unit 40 of the nail printing device 1 to print on the printing area from the nail design data (original data).

The printing data generated by the printing data generator 813 is sent to the nail printing device 1 via the communication units 14, 86, and the print head 41 of the nail printing device 1 prints the nail design based on the printing data on the nail T of the printing finger.

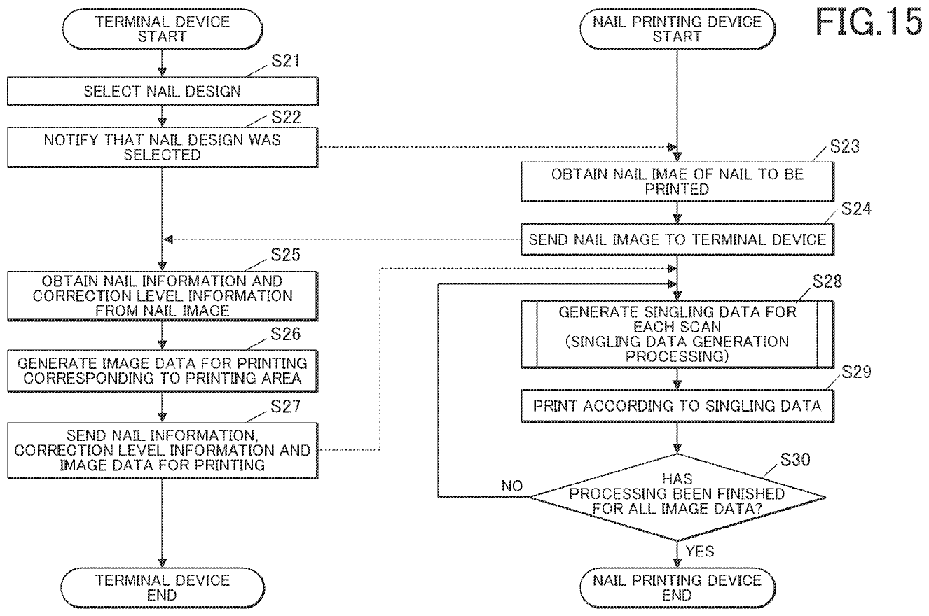

Next, referring to FIG. 15, the action of the printing system 100 in the embodiment will be described.

To perform nail printing using the nail printing device 1 in the embodiment, the user operates the operation unit 21 etc. of the nail printing device 1 to turn on and activate the nail printing device 1.

The user also turns on the terminal device 8, and selects execution of the nail printing processing from the operation unit 84 of the terminal device 8. This will start the nail print AP 821b.

When the nail print AP 821b is started, the display controller 812 of the terminal device 8 displays a list of nail designs and a message instructing the user to select the desired design on the display 85. Next, the user selects the nail design to be printed on nail T by operating the touch panel or other operation unit 84.

By this operation, an operation signal is sent to the control device 80, and the desired nail design is selected as the nail design to be printed on nail T, as shown in FIG. 15 (Step S21).

When the nail design is selected by the user, the notification that the nail design was selected is sent from the terminal device 8 to the nail printing device 1 (Step S22). The controller 31 of the nail printing device 1 photographs the printing finger with the photographing unit 50, and obtains the nail image (Step S23).

The controller 31 then sends the obtained data of the nail image to the terminal device 8 (Step S24).

At the terminal device 8 that received the data of the nail image, the nail information obtainer 813 obtains various nail information and also obtains correction level information (Step S25).

Then, the printing data generator 814 fits the selected nail design to the printing area and generates the image data for printing corresponding to the printing area of the nail T of the present printing finger (Step S26).

The nail information, etc. and the correction level information obtained by the terminal device 8, and the printing data generated by the terminal device 8 are sent to the nail printing device 1 (Step S27).

In the nail printing device 1, the singling data for each line is generated by referring to the correction level information and making appropriate corrections (Step S28), and printing is performed based on the singling data (Step S29).

The controller 31a determines whether or not the processing has been finished for all image data of nail T (Step S30), and if the processing has not been finished (Step S30; NO), returns to Step 28 and repeats the processing.

On the other hand, if the processing has been finished for all image data (Step S30; YES), the printing processing is ended.

Other points are the same as in the first embodiment, and thus the explanation thereof is omitted.

As described above, according to the embodiment, the following effects can be obtained in addition to the same effects as in the first embodiment.

That is, in the embodiment, the obtaining of correction level information, generation of printing data, and the like can be performed by the terminal device 8. Thus, the controller 31 of the nail printing device 1 can be made simpler.

In addition, since it is possible to perform high-precision calculation processing and the calculation speed is faster, faster and more accurate printing processing can be expected.

Although the embodiments of the present invention have been described above, the present invention is not limited to such embodiments and various modifications can be made within the scope of the present invention.

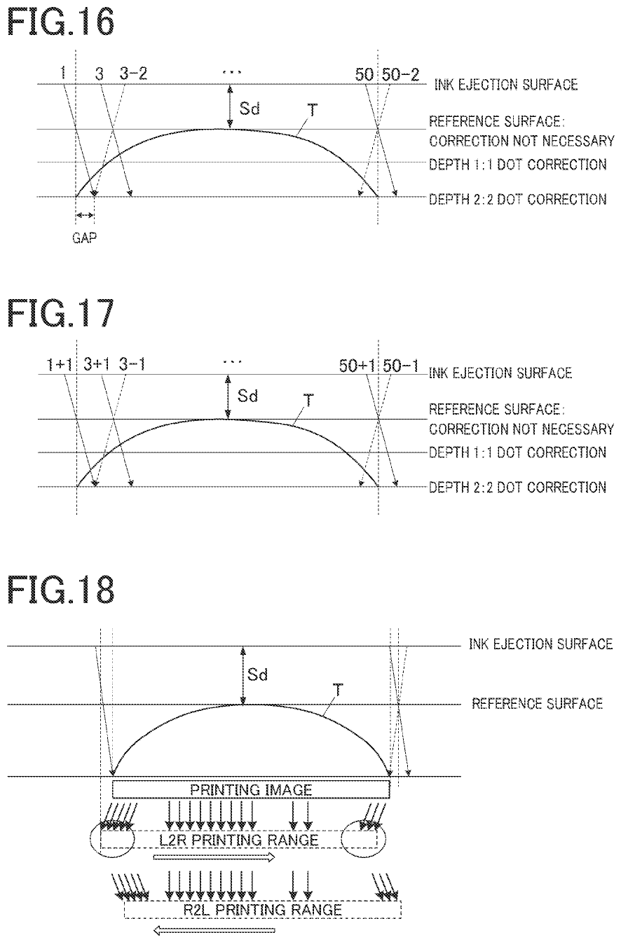

For example, as shown in FIG. 16 etc., the embodiments show, as an example, the case where the ink ejection of the first ink droplet during the movement in the first direction moving from left to right is fixed, and only the ink ejection of the second ink droplet during the movement in the second direction moving from right to left is corrected to match the ink ejection of the first ink droplet. However, as shown in FIG. 17, the ink ejection may be corrected for both of movement in the direction to left and movement in the direction to right, so that the landing positions of both the movements match each other.

In this case, when the depth level is at depth 2 during R2L movement, the image is corrected to shift one pixel earlier. In the L2R movement, for both of the depth levels of depth 1 and 2, the image is corrected by −1.

By correcting for both cases of movement in the left and right directions in this way, the effect of reducing the image shift on the end side of the nail T can be obtained, compared to the case where the ink ejection is fixed for movement in one direction. It is of course possible to fix the ink ejection of the second ink droplet during movement in the second direction moving from right to left, and to correct only the ink ejection of the first ink droplet during movement in the first direction moving from left to right to match the ink ejection of the second ink droplet.

In addition to the correction to eliminate the left-right landing position gap described in the embodiment, a further correction may be made to print the data of the printing image at an earlier position than the original position as it moves toward the end side of the nail T away from the reference surface, as shown in FIG. 18.

In other words, data is printed by virtually shifting the printing range for L2R to the left. In the same way, the printing range for R2L is virtually shifted to the right to print the data. In this way, the printing range is virtually widened at the end of the nail T, and the printing can be beautifully finished to the end of the nail T without any unpainted area.

Although several embodiments of the present invention have been described above, the scope of the present invention is not limited to the embodiments described above, and the scope of the invention includes the scope described in the claims and the equivalent scope thereof.

### INDUSTRIAL APPLICABILITY

There is an industrial applicability in the field of printing device that executes nail printing.

1. A printing device comprising:
an ejector that ejects a first droplet to a print medium partially having a curved surface while moving in a first direction, and ejects a second droplet corresponding to the first droplet to the print medium while moving in a second direction opposite to the first direction; and
at least one processor that obtains correction level information based on a distance between the print medium and the ejector and reference data that associates a correction level with each area obtained by dividing the print medium into multiple areas in a width direction and
that performs ejection control of at least one of ejection of the first droplet by the ejector and ejection of the second droplet by the ejector based on the obtained correction level information so that a landing position on the print medium of the first droplet that the ejector ejects while moving in the first direction and a landing position of the second droplet that the ejector ejects while moving in the second direction substantially match each other.

2. The printing device according to claim 1, wherein the processor obtains the correction level information corresponding to the distance between the print medium and the ejector at a timing when the ejector ejects the first droplet or the second droplet to the print medium.

3. The printing device according to claim 1, wherein the processor controls only the ejection of the second droplet by the ejector based on the obtained correction level information so that the landing position of the second droplet that the ejector ejects while moving in the second direction substantially matches the landing position on the print medium of the first droplet that the ejector ejects while moving in the first direction.

4. The printing device according to claim 1, wherein
the processor performs the ejection control of the first droplet and the second droplet by the ejector by referring to first printing data corresponding to the first droplet and second printing data corresponding to the second droplet, and
the processor changes the first printing data corresponding to the first droplet or the second printing data corresponding to the second droplet based on the obtained correction level information so that the landing position on the print medium of the first droplet ejected by the ejector and the landing position on the print medium of the second droplet ejected by the ejector substantially match each other.

5. The printing device according to claim 4, wherein the processor changes only the second printing data corresponding to the second droplet based on the obtained correction level information so that the second droplet substantially matches the landing position on the print medium of the first droplet by the ejector.

6. The printing device according to claim 4, wherein
the first printing data is printing data in which a timing to eject the first droplet is determined for each printing pixel based on a reference distance between the print medium and the ejector,
the second printing data is printing data in which a timing to eject the second droplet is determined for each printing pixel based on the reference distance between the print medium and the ejector, and
the processor shifts, by one pixel or more, the timing to eject the first droplet by the first printing data or the timing to eject the second droplet by the second printing data based on the obtained correction level information.

7. The printing device according to claim 1, wherein multiple types of the reference data are prepared according to a degree of a curvature of the curved surface of the print medium.

8. The printing device according to claim 1, wherein the processor performs the ejection control of the ejector so as to eject a droplet from before an ejection position in a movement direction of the ejector based on the correction level information, the ejection position being a position where the droplet originally should be ejected from the ejector.

9. A terminal device comprising:
a communicator configured to be communicable with a printing device including an ejector that ejects a first droplet to a print medium partially having a curved surface while moving in a first direction, and ejects a second droplet corresponding to the first droplet to the print medium while moving in a second direction opposite to the first direction; and
a processor that obtains correction level information based on a distance between the print medium and the ejector and reference data that associates a correction level with each area obtained by dividing the print medium into multiple areas in a width direction and
that generates printing information for performing ejection control of the ejector based on the obtained correction level information, wherein
the communicator sends the printing information generated by the processor to the printing device.

10. A printing system comprising:
a printing device including: an ejector that ejects a first droplet to a print medium partially having a curved surface while moving in a first direction and ejects a second droplet corresponding to the first droplet to the print medium while moving in a second direction opposite to the first direction; and a first processor that performs ejection control of the ejector;
a terminal device that includes a communicator configured to be communicable with the printing device; and
a second processor that obtains correction level information based on a distance between the print medium and the ejector and reference data that associates a correction level with each area obtained by dividing the print medium into multiple areas in a width direction and
that generates printing information for performing ejection control of the ejector based on the obtained correction level information, wherein
the first processor of the printing device receives the printing information from the terminal device, and performs the ejection control of at least one of ejection of the first droplet by the ejector and ejection of the second droplet by the ejector so that a landing position on the print medium of the first droplet that the ejector ejects while moving in the first direction and a landing position of the second droplet that the ejector ejects while moving in the second direction substantially match each other.

11. A printing method for a printing device including an ejector that ejects a first droplet to a print medium partially having a curved surface while moving in a first direction and ejects a second droplet corresponding to the first droplet to the print medium while moving in a second direction opposite to the first direction, the method comprising
performing ejection control of at least one of ejection of the first droplet by the ejector and ejection of the second droplet by the ejector, based on correction level information that is based on a distance between the print medium and the ejector and reference data that associates a correction level with each area obtained by dividing the print medium into multiple areas in a width direction, so that a landing position on the print medium of the first droplet that the ejector ejects while moving in the first direction and a landing position of the second droplet that the ejector ejects while moving in the second direction substantially match each other.

12. A non-transitory computer-readable storage medium storing a program for a computer of a printing device, the printing device including an ejector that ejects a first droplet to a print medium partially having a curved surface while moving in a first direction and ejects a second droplet corresponding to the first droplet to the print medium while moving in a second direction opposite to the first direction, the program causing the computer of the printing device to perform
ejection control of at least one of ejection of the first droplet by the ejector and ejection of the second droplet by the ejector, based on correction level information that is based on a distance between the print medium and the ejector and reference data that associates a correction level with each area obtained by dividing the print medium into multiple areas in a width direction, so that a landing position on the print medium of the first droplet that the ejector ejects while moving in the first direction and a landing position of the second droplet that the ejector ejects while moving in the second direction substantially match each other.
